(19) United States
(12) Patent Application Publication
(10) Pub. No.: US 2008/0023572 A1
(43) Pub. Date: Jan. 31, 2008

(54) Porous plate with micro openings, method of producing the same, and atomizer having the same

(75) Inventor: Rodney Lee Clark, Gurley, AL (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NALUX CO., LTD.

(21) Appl. No.: 11/494,640

(22) Filed: Jul. 28, 2006

(51) Int. Cl. B05B 9/00

(52) U.S. Cl. 239/145; 428/409; 430/320

(57) ABSTRACT

A method according to the invention of producing a porous plate in which micro openings with a predetermined size are arranged at a predetermined interval, includes a step of forming a UV curable resin layer on a substrate; a step of performing UV exposure to the UV curable resin layer to form a pattern corresponding to the micro openings; a step of performing development; and a step of peeling off the UV curable resin layer from the substrate to obtain the porous plate.

### BACKGROUND OF THE INVENTION

1. Field of the Invention

The present invention relates to a porous plate in which micro openings with a predetermined size are arranged at a predetermined interval, a method of producing the porous plate, and an atomizer having the porous plate.

2. Description of the Related Art

Porous plates in which micro openings with a predetermined size are arranged at a predetermined interval is utilized for generating a liquid spray (aerosol spray) having a precise droplet size. For example, the porous plates are used in applications such as pharmaceutical delivery of an inhaler, fuel injection and atomization in a combustion engine, and fabrication and packaging of pharmaceuticals.

In the applications, it is important that a droplet size be fine and uniform. A surface to volume ratio of a droplet size is increased as the droplet size is decreased. A surface area is a position where chemical reactions are generated as in the case of combustion. In the case of pharmaceutical delivery, a time for pharmaceutical to enter a blood stream is shortened as the droplet size is decreased. A uniform droplet size is important in properly managing a doze of the pharmaceutical.

FIG. 5 shows a configuration of a pharmaceutical spraying atomizer 200. The atomizer 200 includes a pharmaceutical bottle 205, a vibrator 203, and a porous plate (mesh) 201. When the vibrator 203 is made to vibrate at a predetermined frequency after the pharmaceutical is supplied between the porous plate 201 and the vibrator 203, the pharmaceutical passes through the porous plate 201 to generate particles of the pharmaceutical, and the pharmaceutical is sprayed.

FIG. 6 shows a configuration of a porous plate 201 and vibrator 203. A particle size of the sprayed pharmaceutical depends on an opening shape of the porous plate 201 and the frequency of the vibrator 203. A horn-type vibrator may be used as the vibrator 203. In the horn-type vibrator, a metal conical horn is connected to a piezoelectric element. The porous plate 201 is formed by making many holes having a diameter of several micrometers in a ceramic plate, using an excimer laser, for example,.

However, it takes a lot of time to make many holes having a diameter of several micrometers with an excimer laser, which increases production cost of the porous plate 201.

There is proposed another method of producing the porous plate 201, in which etching holes piercing through a substrate wafer are made based on photolithography. Thick wafers are required so that the final part has sufficient strength. These thick wafers take a long time to completely etch through. Therefore, the production cost is increased.

Under the situation mentioned above, there are needs for a method of producing the porous plate in which micro openings with a predetermined size are arranged at a predetermined interval, at low cost, and for an inexpensive porous plate. There are also needs for an inexpensive atomizer in which the porous plate is used to deliver uniform droplets having a predetermined quantity.

### SUMMARY OF THE INVENTION

A method according to the invention of producing a porous plate in which micro openings with a predetermined size are arranged at a predetermined interval, includes a step of forming a UV curable resin layer on a substrate; a step of performing UV exposure to the UV curable resin layer to form a pattern corresponding to the micro openings; a step of performing development; and a step of peeling off the UV curable resin layer from the substrate to obtain the porous plate.

According to the method, the porous plate in which micro openings with a predetermined size are arranged at a predetermined interval can be obtained at low cost because the method does not take a lot of time by the use of an exposed UV curable resin layer.

A porous plate according to the invention in which micro openings with a predetermined size are arranged at a predetermined interval is produced by the porous plate producing method according to the invention.

Accordingly, the porous plate according to the invention in which the micro openings with a predetermined size are arranged at a predetermined interval can be produced at low cost.

An atomizer according to the invention includes the porous plate according to the invention in which micro openings with a predetermined size are arranged at a predetermined interval.

Accordingly, the atomizer of the invention can deliver uniform droplets having a predetermined quantity, and the atomizer can be produced at low cost.

### BRIEF DESCRIPTION OF THE DRAWINGS

FIG. 1 is a flowchart showing a method according to an embodiment of the invention of producing a porous plate in which micro openings with a predetermined size are arranged at a predetermined interval;

FIG. 2 is a view for explaining the method according to the embodiment of the invention of producing the porous plate in which the micro openings with a predetermined size are arranged at a predetermined interval;

FIG. 3 shows an example of a porous plate according to the invention in which micro openings with a predetermined size are arranged at a predetermined interval;

FIG. 4 shows micro openings on a porous plate;

FIG. 5 shows a configuration of a atomizer for spraying pharmaceutical; and

FIG. 6 shows a configuration of a porous plate and a vibrator.

### DESCRIPTION OF THE PREFERRED EMBODIMENT

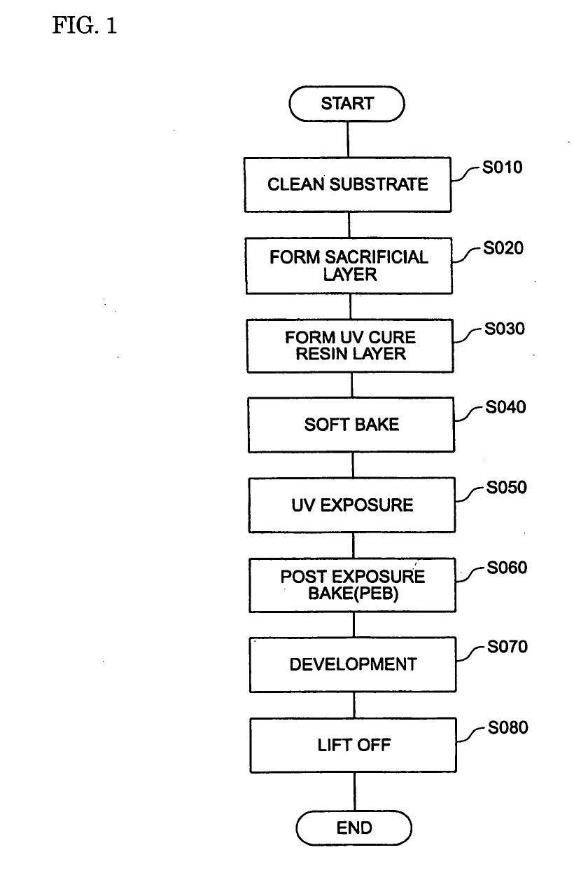

FIG. 1 is a flowchart showing a method of producing a porous plate according to an embodiment of the invention, in which micro openings with a predetermined size are arranged at a predetermined interval.

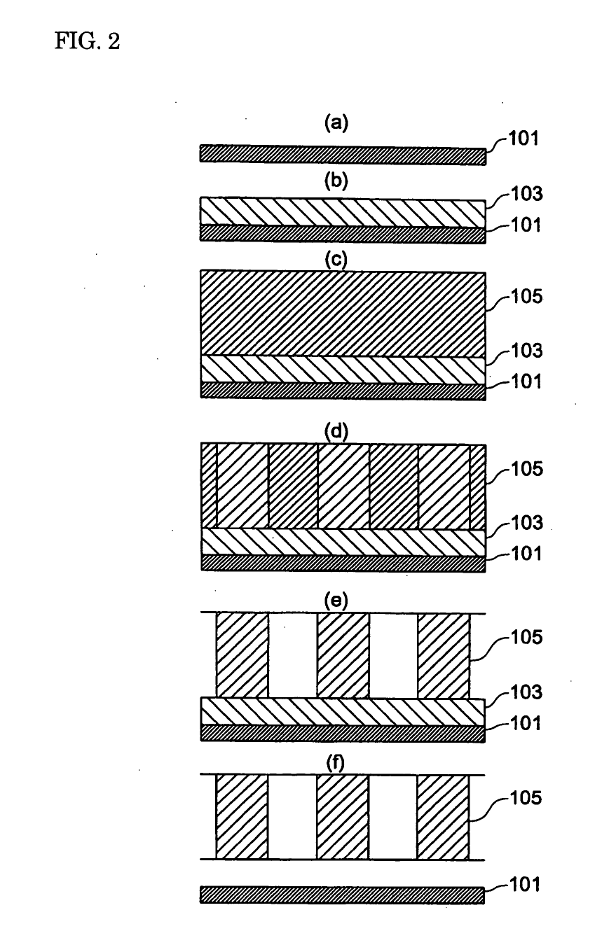

FIG. 2 is a view for explaining the method of the embodiment of producing the porous plate in which the micro openings with a predetermined size are arranged at a predetermined interval.

In Step S010 shown in FIG. 1, a substrate 101 is washed in a wet washing manner. The substrate 101 is formed by a silicon wafer or the like. FIG. 2(a) shows the substrate 101.

In Step S020 shown in FIG. 1, a sacrifice layer 103 is formed on the substrate 101. FIG. 2(b) shows the sacrifice layer 103 formed on the substrate 101. As described later, the sacrifice layer 103 is used to peel off a layer formed on the sacrifice layer 103. In the embodiment, a positive type UV resist is used as the sacrifice layer 103. In forming the sacrifice layer 103, the positive type UV resist is applied on the substrate 101 by spin coating, and pre-baking is performed. The spin coating is performed at a speed of 1500 rpm. In the pre-baking, the substrate 101 is placed on a hot plate whose temperature is set at 90° C., for 90 seconds.

In Step S030 shown in FIG. 1, a UV curable resin layer 105 is formed on the sacrifice layer 103. FIG. 2(c) shows the UV curable resin layer 105 formed on the sacrifice layer 103. When the UV curable resin layer 105 is formed, a UV curable resin is applied by the spin coating. A thickness of the coated layer is 100 micrometers. The spin coating (rotation) is performed as follows. The substrate 101 is accelerated up to 500 rpm with an acceleration of 100 rpm/s, and the substrate 101 is maintained at 500 rpm for five seconds. Then, the substrate 101 is accelerated up to 1400 rpm with an acceleration of 300 rpm/s, and the substrate 101 is maintained at 1400 rpm for 50 seconds. SU-8 (a product of MicroChem, United States) which is of a negative type epoxy resist may be used as the UV curable resin.

The substrate is maintained in a horizontal position for at least one hour before soft-baking is performed, in order to decrease an edge bead and to have the UV curable resin layer 105 as flat as possible.

In Step S040 shown in FIG. 1, soft-baking is performed in order to volatilize a solvent of the UV curable resin layer 105 to harden the UV curable resin layer 105. The soft-baking may be performed using a hot plate. In this case, the substrate 101 is placed on the hot plate whose temperature is set at 95° C., for 30 seconds. After the soft-baking, the substrate 101 is cooled for 10 minutes or more.

In Step S050 shown in FIG. 1, the UV curable resin layer 105 and the sacrifice layer 103 formed by the positive type UV resist are exposed with an ultraviolet ray. The UV exposure is performed with a micro-opening pattern using a mask aligner. FIG. 2(d) shows a state in which the UV curable resin layer 105 formed on the sacrifice layer 103 is exposed with the ultraviolet ray.

The UV curable resin such as SU-8 having the thickness of 100 micrometers requires an UV irradiation amount of 400 mJ/cm². In order to avoid heating during the exposure, it is preferable to alternately repeat a 15 second exposure period and a one minute delay period (period during which the exposure is not performed). In the embodiment, entire exposure time is 90 seconds (six 15-second exposure periods).

The substrate 101 is cooled for 10 minutes before post-exposure baking.

In Step S060 shown in FIG. 1, the post-exposure baking is performed to promote cross-linking of the exposed portion. The post-exposure baking may be performed using a hot plate. In this case, the substrate 101 is placed on the hot plate whose temperature is set at 95° C., for 15 minutes. After the post-exposure baking, the substrate 101 is cooled for 15 minutes in advance of development.

In Step S070 shown in FIG. 1, development is performed to remove portions which has not been exposed to the UV irradiation. An organic development solution is used for the development. Propylene glycol methyl ether acetate (PGMEA) may be used as the development solution. The substrate 101 is soaked in a high-purity PGMEA for eight minutes. Then, the rinsing is performed with isopropanol (IPA). FIG. 2(e) shows a state in which the UV curable resin layer 105 formed on the sacrifice layer 103 is developed.

In Step S080 shown in FIG. 1, the UV curable resin layer 105 is peeled off from the substrate 101. An inorganic alkaline development solution (for example, MF-351 development solution produced by Rohm & Haas Microelectronics) is used for peeling off the UV curable resin layer 105. The substrate 101 is soaked in a development solution vessel placed on a hot plate whose temperature is set at room temperature. The hot plate may be rotated in the range of 1000 to 1500 rpm to promote the lift-off process. FIG. 2(i) shows the cured resin layer 105 which has been peeled off from the substrate 101. The cured resin layer 105 becomes the porous plate with micro openings.

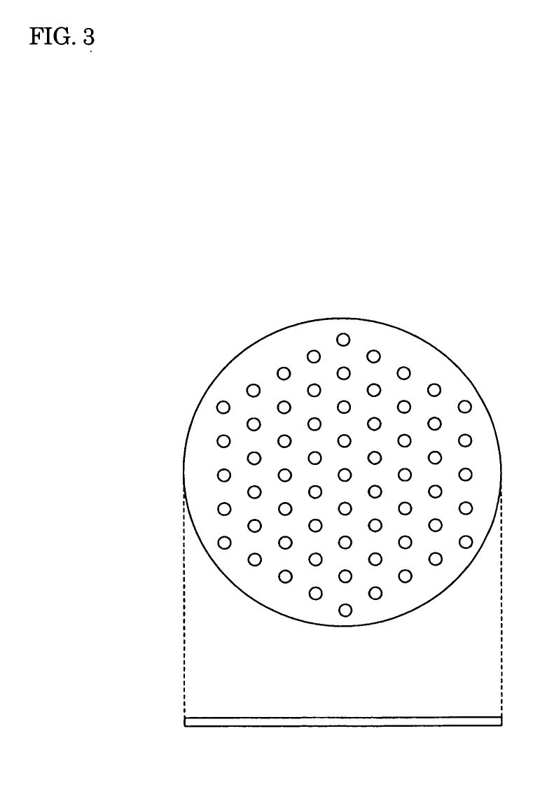

FIG. 3 shows an example of a porous plate according to the invention in which the micro openings with a predetermined size are arranged at a predetermined interval. The porous plate according to the invention is produced by the above method. The porous plate is formed in a circular shape. For example, the porous plate has a diameter of six millimeters. For example, the porous plate has a thickness of 100 micrometers. In FIG. 3, size of the micro openings is enlarged.

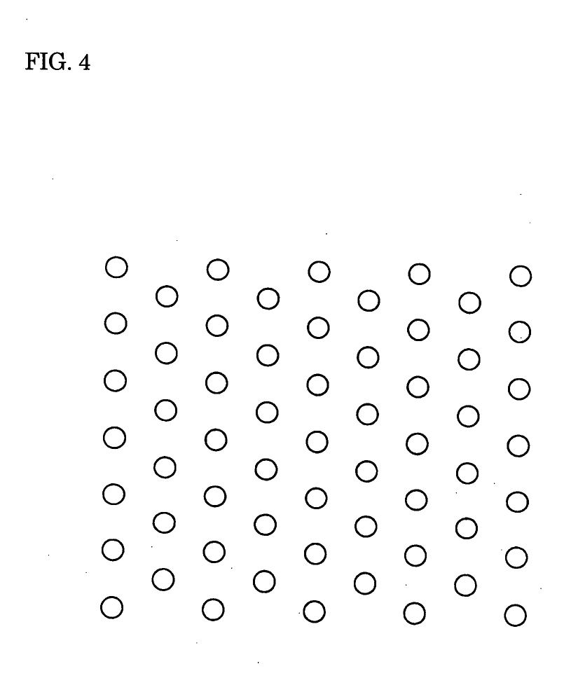

FIG. 4 shows micro openings on the porous plate. In the embodiment, a cross section of each opening has a circular shape and the interval between the openings is 60 micrometers. The openings may be tapered. A diameter of each opening having a circular cross section, is 30 micrometers in the upper surface of the porous plate, while a diameter of the opening may range from 3 to 5 micrometers in the lower surface.

When the porous plate is used for a pharmaceutical spraying atomizer, a diameter (minimum diameter) of openings in the porous plate is preferably several micrometers and the interval between the openings preferably ranges from 30 to 60 micrometers. The number of the openings in the porous plate is preferably not lower than 1000.

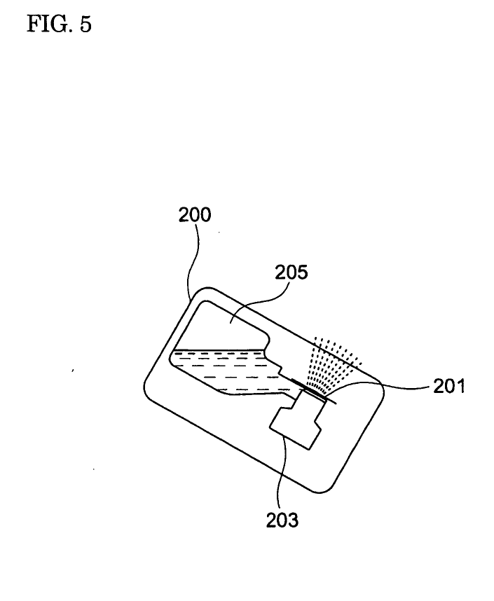

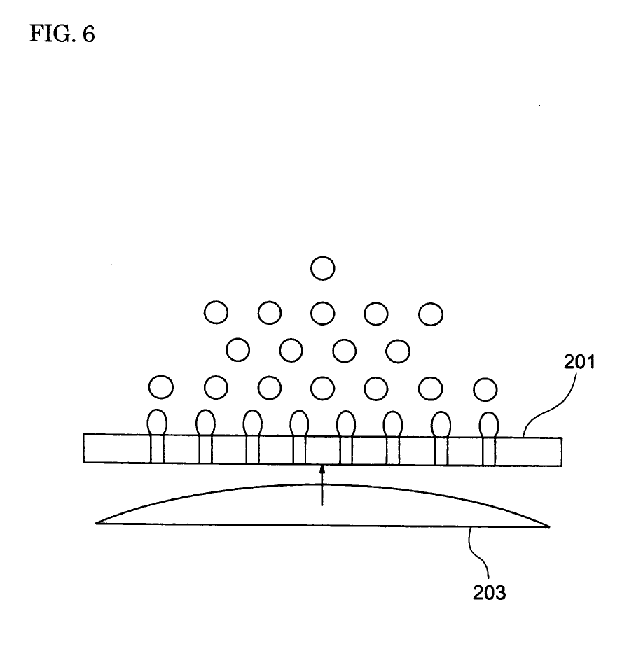

The configuration of the pharmaceutical spraying atomizer according to an embodiment of the invention is similar to that of the atomizer shown in FIG. 5. The configurations of the porous plate and vibrator of the embodiment of the invention are similar to that of the porous plate shown in FIG. 6. However, in the embodiment a porous plate 201 is produced by the producing method described above.

According to the invention, a porous plate in which micro openings with a predetermined size are arranged at a predetermined interval can be produced at low cost. Furthermore, the invention can provide an inexpensive porous plate and an inexpensive atomizer in which the porous plate of the invention is used to deliver uniform droplets having a predetermined quantity.

What is claimed:

1. A method of producing a porous plate in which micro openings with a predetermined size are arranged at a predetermined interval, the method comprising:
a step of forming a UV curable resin layer on a substrate;
a step of performing UV exposure to the UV curable resin layer to form a pattern corresponding to the micro openings;
a step of performing development; and
a step of peeling off the UV curable resin layer from the substrate to obtain the porous plate.

2. A method of producing a porous plate having micro openings according to claim 1, further comprising a step of forming a sacrifice layer between the substrate and the UV curable resin layer.

3. A method of producing a porous plate having micro openings according to claim 2, wherein a positive type UV resist is used as the sacrifice layer.

4. A method of producing a porous plate having micro openings according to claim 1, further comprising a step of performing soft-baking between the step of forming the UV curable resin layer on the substrate and the step of performing UV exposure.

5. A method of producing a porous plate having micro openings according to claim 1, further comprising a step of performing post-exposure baking between the step of performing the UV exposure and the step of performing development.

6. A method of producing a porous plate having micro openings according to claim 1, wherein the substrate is a silicon wafer.

7. A porous plate wherein micro openings with a predetermined size are arranged at a predetermined interval, wherein the porous plate is produced by a method according to claim 1.

8. An atomizer comprising:
a porous plate which has micro openings according to claim 7;
a vibrator;
a container in which a sprayed liquid is stored,
wherein the vibrator is vibrated to deliver the liquid, stored in the container, in a form of a uniform size droplet through the micro openings of the porous plate.
